(19) United States
(12) Patent Application Publication
(10) Pub. No.: US 2026/0204117 A1
(43) Pub. Date: Jul. 16, 2026

(54) SUPPLEMENTARY ACCESS CONTROL SYSTEM FOR AN RFID-CONTROLLED CAT FLAP AND METHOD FOR SUPPLEMENTARY ACCESS CONTROL USING AN RFID-CONTROLLED CAT FLAP

(71) Applicant: Thomas Prosser, Unterschleissheim (DE)

(72) Inventor: Thomas Prosser, Unterschleissheim (DE)

(21) Appl. No.: 18/879,549

(22) PCT Filed: Jun. 27, 2023
(86) PCT No.: PCT/EP2023/067412

§ 371 Date: Mar. 19, 2026

(30) Foreign Application Priority Data
Jun. 28, 2022 (DE) 10 2022 116 065.3

(51) Int. Cl. G07C 9/32; E06B 7/32; G06V 10/82; G06V 40/10

(52) U.S. Cl. CPC G07C 9/32; E06B 7/32; G06V 10/82; G06V 40/10; G07C 2209/08

(57) ABSTRACT

A supplementary access control system for an RFID-controlled cat flap includes a sensor for detecting an approaching cat and a camera for recording at least one image of the approaching cat, an image processing unit that is coupled to the camera and configured to determine, on the basis of the at least one image, whether the cat is carrying a prey animal in its mouth; a radio-frequency signal generator that is configured to transmit an interfering signal, wherein the interfering signal is suitable for preventing an opening of the RFID-controlled cat flap, and a control unit that is coupled to the sensor, to the image processing unit, and to the radio-frequency signal generator, wherein the control unit is configured: on the basis of the detection of the approaching cat, to cause the radio-frequency signal generator to transmit the interfering signal; and on the basis of the determination by the image processing unit that the cat is not carrying a prey animal in its mouth, to cause the radio-frequency signal generator to end the transmission of the interfering signal.

This application is a national stage application of PCT Patent Appln. No. PCT/EP2023/067412 filed Jun. 27, 2023, which claims priority to DE Patent Appln. No. 10 2022 116 065.3 filed Jun. 28, 2022, which are herein incorporated by reference.

### BACKGROUND OF THE INVENTION

### 1. Technical Field

The present invention pertains to the field of cat flaps. In particular, the present invention is in the field of RFID-controlled cat flaps.

### 2. Background Information

Cat flaps/pet doors are technical systems that allow a cat to access a building without the necessity of a house door, balcony door, window or the like being open. Cat flaps usually allow cats the exit from a building and the entry into a building.

RFID-controlled cat flaps are widely used. These have the purpose that not every arbitrary cat is granted access to a building through the cat flap, but only one or more predetermined cats. RFID-controlled cat flaps remain closed as long as a cat approaching the RFID-controlled cat flap cannot be identified by an RFID tag and the control system of the cat flap determines that the detected RFID tag is recorded as belonging to a predetermined cat and releases the opening of a pivotable door element.

Although RFID-controlled cat flaps constitute a large step forward in comparison with simple mechanical cat flaps, they are not ideal for controlling access to a building under all circumstances. For example, RFID-controlled cat flaps are dependent on the approaching cat wearing an RFID tag. In this case, wearing the RFID tag in the collar is not ideal due to the risk of loss of the collar. Implanting RFID tags is not always desired for animal protection reasons. Also, existing RFID-controlled cat flaps are not capable of prohibiting cats, carrying prey animals, from entry into the house.

Accordingly, it would be desirable to provide systems and methods that can overcome one or more of the shortcomings in RFID-controlled cat flaps described hereinbefore.

### SUMMARY

Exemplary embodiments of the invention comprise a supplementary access control system for an RFID-controlled cat flap, comprising: a sensor for detecting an approaching cat and a camera for taking/recording at least one image of the approaching cat; an image processing unit that is coupled to the camera and configured to determine, on the basis of the at least one image, whether the cat is carrying a prey animal in its mouth; a radio-frequency signal generator configured to transmit an interfering signal, wherein the interfering signal is suitable for preventing an opening of the RFID-controlled cat flap; and a control unit coupled to the sensor, to the image processing unit and to the radio-frequency signal generator, wherein the control unit is configured: to cause the radio-frequency signal generator, on the basis of the detection of the approaching cat, to transmit the interfering signal; and to cause the radio-frequency signal generator, on the basis of the determination by the image processing unit that the cat is not carrying a prey animal in its mouth, to terminate the transmission of the interfering signal.

Exemplary embodiments of the invention allow for an overriding of an RFID-controlled cat flap until it has been positively determined that the cat is not carrying a prey animal in its mouth. In this context, no manipulations need to be performed on the technical system of RFID-controlled cat flap and RFID tag worn by the cat. Existing RFID-controlled cat flaps can be supplemented very conveniently by the functionality that an in principle access-authorized cat, which is carrying a prey animal in its mouth, is denied access. The undesired introduction of living or dead prey animals, such as mice, birds, etc. can be implemented highly efficiently in an existing system architecture of RFID-controlled cat flap and RFID tag.

The access control system is described as a supplementary access control system as it cooperates with the access control system of the RFID-controlled cat flap, which is functioning as such, but is more restricted in its functionality. The supplementary access control system supplements functionality. The supplementary access control system can also be referred to as an additional access control system or as a superordinate access control system. It uses the functioning access control system of RFID-controlled cat flap and RFID tag worn by the cat as a basis.

The control unit of the supplementary access control system is coupled to the sensor, to the image processing unit and to the radio-frequency signal generator and is configured to cause the radio frequency generator, on the basis of the detection of the approaching cat, to transmit the interfering signal and to cause the radio frequency generator, on the basis of the determination by the image processing unit that the cat is not carrying a prey animal in its mouth, to terminate / end the transmission of the interfering signal. Thus, the control unit is configured to control the transmission of the interfering signal by the radio frequency generator in such a way that the RFID-controlled cat flap does not open as long as the image processing unit does not determine that the cat is not carrying a prey animal in its mouth. By way of the mechanism of sending/transmitting the interfering signal upon detection of the approaching cat and terminating the transmission of the interfering signal after determination by the image processing unit that the cat is not carrying a prey animal in its mouth, it can be effectively prevented that the RFID-controlled cat flap allows an opening thereof immediately when an in principle access-authorized cat is identified. By means of the supplementary access control system, a secure default state is achieved first, in which the RFID-controlled cat flap does not provide access to the cat. Only after an active determination that the cat is not carrying a prey animal in its mouth and after a termination of the transmission of the interfering signal, the RFID-controlled cat flap and the RFID tag of the cat are capable of communicating with one another in such a way that the RFID-controlled cat flap enables an opening thereof.

The image processing unit is configured to determine, on the basis of the at least one image, whether the cat is carrying a prey animal in its mouth. In other words, the image processing unit is configured to analyze the at least one image with respect to whether the cat is carrying a prey animal in its mouth. The image processing unit makes a determination which, for example, may be in the form of a yes/no decision. It is also possible for the image processing unit to output a relative indicator, such as e.g. a probability value whether the cat is carrying a prey animal in its mouth. The control unit can then control the radio-frequency signal generator by means of a corresponding logic, e.g. by means of a corresponding threshold value for the probability value. The image processing unit is configured to make a determination on the basis of the at least one image whether the cat is carrying a prey animal in its mouth. In this regard, the image processing unit does not have to provide a result that is correct in 100% of the cases. It is apparent that a reliability of 100% cannot always be achieved with respect to the multiplicity of degrees of freedom given when recording the at least one image.

The supplementary access control system has a camera for recording at least one image of the approaching cat. The camera is a digital camera. The camera can be equipped with a light source for illumination of the approaching cat or can be coupled to such a light source. The light source can be an LED, in particular an LED that emits white light. The light source may be controlled to output light after detection of the approaching cat for a predetermined period of time and to provide for continuous illumination during this time. It is also possible for the light source to be coupled to the trigger time for recording the at least one image in the manner of a photo flash. The light source can be turned on or not turned on depending on the ambient brightness.

According to a further embodiment, the image processing unit is configured to analyze the at least one image with an artificial intelligence as to whether the cat is carrying a prey animal in its mouth. The inventors have found that, with the aid of an artificial intelligence, an image processing unit can be implemented which can determine with high reliability whether or not the cat is carrying a prey animal in its mouth. It has been found that an artificial intelligence is very suitable for handling the many degrees of freedom of the images of the approaching cat under different environmental conditions and for achieving high accuracy in the evaluation of the recorded images. Here, the term artificial intelligence relates to a data processing entity that is not produced by conventional programming, but is the product of a machine learning process based on training images.

According to a further embodiment, the artificial intelligence has a neural network. In particular, the artificial intelligence can have a convolutional neural network. The term convolutional neural network is known to a person skilled in the art as a fixed term and can be translated in German as a “faltendes” (i.e. folding) neural network. The neural network described herein is an artificial neural network. An example of a suitable neural network is MobileNet by Keras. It is to be understood that this example is of purely exemplary nature and that there are many different neural networks that can be used in the image processing unit of the present invention.

According to a further embodiment, the artificial intelligence is a pre-trained artificial intelligence. In particular, the artificial intelligence can be a pre-trained artificial intelligence that has been trained with at least 200 images of cats without prey animals in the mouth and at least 200 images of cats with prey animals in the mouth, which are correspondingly annotated. Further in particular, the artificial intelligence may have been trained with between 500 images and 1500 images of cats without prey animals in the mouth and between 500 images and 1500 images of cats with prey animals in the mouth, which are correspondingly annotated. The images of cats without prey animals in the mouth can be images of more than 20 different cats. The images of cats with prey animals in the mouth can also be images of more than 20 different cats. Due to the fact that prey animals are usually only once prey animals, a comparable number of different prey animals can be present in the images of cats with prey animals in the mouth. A very good basic robustness of the artificial intelligence can be achieved with the stated numbers of images of cats without prey animals in the mouth and images of cats with prey animals in the mouth. After training with the above-mentioned numbers of images of cats without prey animals in the mouth and images of cats with prey animals in the mouth, it may be possible to achieve, in a new image to be analyzed with respect to the determination as to whether the cat is carrying a prey animal in its mouth, a hit rate of more than 95%, in particular a hit rate of more than 99%. It is apparent that there is an interaction between the number of images that are available for training the artificial intelligence and the hit rate achievable during operation. If one is satisfied with a lower hit rate, a smaller number of images can be sufficient for training the artificial intelligence. Conversely, with an increase in the annotated images available for the training, the hit rate achievable during operation can be increased.

According to a further embodiment, the images of cats with prey animals in the mouth are images of cats with mice in the mouth and/or images of cats with birds in the mouth and/or images of cats with other prey animals in the mouth.

According to a further embodiment, the control unit is configured to cause the radio frequency generator to transmit the interfering signal during predetermined blocking times, irrespective of whether the image processing unit determines that the cat is carrying or not carrying a prey animal in its mouth. In this way, the supplementary access control system may implement blocking times for the RFID-controlled cat flap, without any such functionality having to be provided in the RFID-controlled cat flap itself. Accordingly, the entry of a cat into a building and/or the exit of a cat from a building during times representing preferred hunting times for cats can be categorically excluded. In this way, the risk of entry of a cat with a prey animal in the mouth can be further reduced. Blocking times can also be conveniently implemented for other purposes without the necessity of manipulating the RFID-controlled cat flap. During the predetermined blocking times, the control unit can cause the radio-frequency signal generator to transmit the interfering signal as long as the sensor detects the presence of the cat. It is also possible for the control unit to cause the radio-frequency signal generator to continuously transmit the interfering signal during the predetermined blocking times. It is furthermore possible that the supplementary access control system comprises a sensor system which detects a communication between the RFID-controlled cat flap and an RFID tag, and that, upon detection of such a communication during the predetermined blocking times, the control unit causes the radio-frequency signal generator to transmit the interfering signal.

According to a further embodiment, the control unit is configured to cause the radio frequency generator to transmit the interfering signal as a function of one or more of the input variables of time, weather data, season time and temperature, irrespective of whether the image processing unit determines that the cat is carrying or not carrying a prey animal in its mouth. Thus, additional blocking functionality can be implemented with the aid of the supplementary access control system, without any such functionality having to be provided in the RFID-controlled cat flap itself. For example, the control unit can ensure that the RFID-controlled cat flap remains closed in the event of rain, unless the temperature drops below a critical value. The logic implemented in the control unit for blocking the RFID-controlled cat flap can take account of one or more of the afore-mentioned input variables in any combination.

According to a further embodiment, the radio-frequency signal generator is designed to transmit an interfering signal having a fundamental frequency of between 100 kHz and 200 kHz, in particular a fundamental frequency of between 120 kHz and 140 kHz. In this way, the radio-frequency signal generator is very well suited to effectively interfere with/disturb frequently used RFID frequencies of 125 kHz and 134 kHz.

According to a further embodiment, the radio-frequency signal generator has a resonant circuit. In this case, the components of the resonant circuit, in particular one and more capacitors and one or more inductors, can be designed to provide an interfering signal with a fundamental frequency in the above-mentioned frequency ranges.

According to a further embodiment, the radio-frequency signal generator is designed to modulate a random or pseudo-random identification number onto a fundamental oscillation of the interfering signal. In this way, the radio-frequency signal generator can pretend an identification that is, with the utmost probability, not stored in the RFID-controlled cat flap and thus cannot lead to the RFID-controlled cat flap being opened. The pseudo-random identification number may be predefined or may be generated when the interfering signal is emitted.

According to a further embodiment, the radio-frequency signal generator is designed to modulate a random or pseudo-random bit pattern onto a fundamental oscillation of the interfering signal. In this way, the radio-frequency signal generator can provide a data pattern which cannot be decoded or does not correspond to an expected communication protocol of the RFID-controlled cat flap and thus is not appropriate from the point of view of the RFID-controlled cat flap. The pseudo-random bit pattern may be predefined or may be generated when the interfering signal is emitted.

The modulation of the fundamental oscillation of the interfering signal can be an amplitude modulation, a frequency modulation, a phase modulation or any other suitable modulation.

The radio-frequency signal generator may prevent an opening of the cat flap in two ways. On the one hand, the radio-frequency signal generator can generate an overall signal by superimposing the interfering signal and the emitted identification of the RFID tag of the cat, which cannot be sensibly decoded by the RFID-controlled cat flap. On the other hand, the radio-frequency signal generator can prevent an opening of the cat flap by the active provision of an identification that is not stored in the RFID-controlled cat flap.

The radio-frequency signal generator can actively emit the interfering signal or provide the interfering signal in the form of a passive or substantially passive reaction to an emitted read signal of the RFID-controlled cat flap. Within the framework of the passive provision of the interfering signal, the radio-frequency signal generator e.g. can turn its resonant circuit on and off in random or pseudo-random sequence or can change the parameters of its resonant circuit in random or pseudo-random sequence. Depending on the technology used, such changes in the resonant circuit of the radio-frequency signal generator, from the point of view of the RFID-controlled cat flap, are understood as a modulation of the inductive load or as a modulation of the reflection of the emitted signal, i.e. as a modulation of the so-called backscatter. Since passive RFID tags also provide such types of feedback to the RFID-controlled cat flap, the behavior of a radio-frequency signal generator, which is operated in the above-described passive mode, is perceived as a source of interference. The passively operated radio-frequency signal generator can be regarded as an entity that emulates the behavior of a passive RFID tag without transmitting meaningful information. Irrespective of whether the radio-frequency signal generator has an active or passive implementation, it is considered herein to be a component that sends or transmits an interfering signal. From the point of view of the RFID-controlled cat flap, the influence of the radio-frequency signal generator on the communication between the RFID-controlled cat flap and the RFID tag worn by a cat is perceived as a reception of an interfering signal.

According to a further embodiment, the radio-frequency signal generator has a transmission power which is in the same order of magnitude as or greater than the transmission power of RFID tags usually employed in animal identification. A comparable transmission power can suffice for effectively disturbing the communication between RFID-controlled cat flap and RFID tag, and such a transmission power level can be provided in a very energy-saving manner.

According to a further embodiment, the supplementary access control system further comprises a network connection/port. In particular, the supplementary access control system may comprise a wireless network connection, such as e.g. a WLAN connection. The supplementary access control system can be conveniently parameterized via a network connection. Also, the network connection may be used to implement the supplementary access control system as a distributed system, wherein part of the components is arranged near the RFID-controlled cat flap, which are also referred to as local components herein, and other components are arranged remote from the RFID-controlled cat flap. By means of the network connection, those components of the supplementary access control system which are arranged near the RFID-controlled cat flap can correspond with an external data processing entity, such as e.g. with an external server. The supplementary access control system can also be monitored and/or controlled via a user interface, such as e.g. a smartphone app or a tablet app. A partially cloud-based implementation of the supplementary access control system is also possible.

According to a further embodiment, the supplementary access control system is a distributed system, in which the image processing unit or part of the image processing unit is implemented remotely from the sensor, the camera, the radio-frequency signal generator and the control unit. In particular, the sensor, the camera, the radio-frequency signal generator, the control unit and, optionally, part of the image processing unit can be designed as an integrated device that can be arranged close to the RFID-controlled cat flap. This device can be referred to as local device or as a local part of the supplementary access control system. The local device may comprise the network connection, via which the device can communicate with the remotely implemented image processing unit or with the remotely implemented part of the image processing unit. In this way, a computing power-intensive implementation of the image processing unit can be split between a local device and a backend purely designed for data processing, such as an external server, for example. An optimized compromise between local energy consumption, size of the device close to the RFID-controlled cat flap and implementation costs can be achieved in this way.

According to a further embodiment, the supplementary access control system is configured to transmit the at least one image to the remote image processing unit via the network connection and to receive the determination of the image processing unit as to whether the cat is carrying a prey animal in its mouth via the network connection. In this way, the image processing unit can be implemented without the technical limitations of the local device close to the RFID-controlled cat flap, in particular without the restrictions with respect to local computing power and local storage capacity.

According to a further embodiment, the control unit and the image processing unit are integrated. In particular, the control unit and the image processing unit can be jointly integrated in the local device that can be arranged close to the RFID-controlled cat flap. The control unit and the image processing unit can be implemented, for example, in a common microcontroller.

According to a further embodiment, the image processing unit, when it is provided locally in this manner, is configured to receive an installation of an artificial intelligence trained with an extended data base via the network connection. In other words, even in the case of a locally implemented image processing unit, it may be possible, by means of corresponding updates, to achieve higher reliability in determining whether the cat is carrying a prey animal in its mouth.

According to a further embodiment, the supplementary access control system is configured to receive changed blocking times via the network connection. In this way, the supplementary access control system can be conveniently parameterized in a further dimension during operation.

According to a further embodiment, the supplementary access control system is configured to receive the time and/or the date and/or weather data and/or temperature data via the network connection. In this way, further data, which can optionally be used for additional functionality of the supplementary access control system, can be conveniently made available from the outside.

According to a further embodiment, the sensor is a passive infrared sensor. With a passive infrared sensor, a particularly reliable detection of an approaching cat can be rendered possible, with the implementation by means of a passive infrared sensor being very energy-saving.

According to a further embodiment, the passive infrared sensor is configured to cause the supplementary access control system to transition from a standby state to an operating state on the basis of the detection of the approaching cat. In this way, if necessary, the passive infrared sensor can wake up the supplementary access control system, as a result of which the extended operation in the energy-saving standby state is possible. An implementation with an overall low power requirement can be rendered possible.

According to a further embodiment, the sensor is configured as a distance sensor. Additionally or alternatively, the supplementary access control system may comprise an additional distance sensor coupled to the control unit. By providing a distance sensor, a quantitative statement can be made as to how close the cat is to the distance sensor and thus to the other components of the supplementary access control system. This information can be taken into account in controlling the other components. It is also possible that, by the provision of a distance sensor, a statement can be made as to whether the cat is located in a specific area of the supplementary access control system. The distance sensor can be designed as a kind of light barrier. Also, such information can be taken into account in controlling the other components.

According to a further embodiment, the sensor or the additional distance sensor provides a signal indicating the distance of the approaching cat, and the control unit is configured to control the triggering time for recording the at least one image on the basis of the distance of the approaching cat. In this way, relatively constant conditions can be achieved for the size of the head of the cat in the at least one image and for the illumination of the head of the cat in the at least one image. This in turn can contribute to a particularly high hit rate in the determination of whether the cat is carrying a prey animal in its mouth.

According to a further embodiment, the sensor configured as distance sensor or the additional distance sensor is configured to continuously monitor the presence of the approaching cat. In particular, the control unit can be configured to perform the control of the radio-frequency signal generator on the basis of the continuous monitoring by the sensor or the additional distance sensor. In particular, the control unit can be designed to cause the radio-frequency signal generator to transmit the interfering signal as long as the presence of the approaching cat is indicated by the sensor or the additional distance sensor, unless the image processing unit determines that the cat is not carrying a prey animal in its mouth. As a result of the coupling to the actual presence of the cat, as detected by the sensor or the additional distance sensor, the transmission of the interfering signal can be implemented without any kind of assumption about the communication between the RFID-controlled cat flap and the RFID tag worn by the cat, and it is possible to achieve an extremely reliable blocking of the RFID-controlled cat flap if the cat is carrying a prey animal in its mouth.

According to a further embodiment, the supplementary access control system is an autonomously operating system. Herein, the term autonomously operating system means that the supplementary access control system does not require any control or commands from outside the system during operation. In particular, it is not necessary for a data connection or control connection to exist between the RFID-controlled cat flap and the supplementary access control system. The supplementary access control system can fulfill its additional functionality via the transmission or non-transmission of the interfering signal and does not have to exchange information therebeyond with the RFID-controlled cat flap.

According to a further embodiment, the supplementary access control system has an internal power supply. The supplementary access control system can in particular comprise a rechargeable battery. In this way, the supplementary access control system can be operated independently of a power connection, in particular independently of a power connection to a building network. It is also possible for the supplementary access control system to be supplied with electrical energy continuously or at intervals as required. For this purpose, the supplementary access control system may comprise a commercially available plug which can be inserted into a domestic socket/outlet.

According to a further embodiment, the supplementary access control system can be mounted to the RFID-controlled cat flap or to a building structure. This means that the supplementary access control system can be mechanically mounted to the RFID-controlled cat flap or the building structure. No electrical connection is necessary. The supplementary access control system can be arranged as a stand-alone or independent system for cooperation with the RFID-controlled cat flap. The supplementary access control system can be retrofitted in existing RFID-controlled cat flaps. Retrofitting of a supplementary access control system in the architecture of existing RFID-controlled cat flaps is possible.

According to a further embodiment, the supplementary access control system has a frame structure which can be inserted into a door breakthrough and/or into a window breakthrough and/or into a wall breakthrough and/or which can be attached to an RFID-controlled cat flap. In particular, the frame structure of the supplementary access control system can be attachable to a frame structure of the RFID-controlled cat flap. Thus, the frame structures of the RFID-controlled cat flap and of the supplementary control system can form a common passage/common tunnel, through which the cat gets access to the building. The mechanical architecture of the supplementary control system can thus be matched to the mechanical architecture of the RFID-controlled cat flap, such that neither a changed use behavior is necessary for the cat nor an optical impairment is caused by the supplementary access control system for the human person.

According to a further embodiment, the radio-frequency signal generator has a coil as an antenna, which is arranged in the frame structure of the supplementary access control system. In this way, the frame structure can fulfill the dual function of a passage matched to the RFID-controlled cat flap and a carrier structure for the antenna of the radio-frequency signal generator.

According to an alternative embodiment, the radio-frequency signal generator has a coil as an antenna, which is not arranged in the frame structure. The complete radio-frequency signal generator including the antenna can be accommodated in an electronics housing, for example.

According to a further embodiment, the camera is arranged on the side of the frame structure facing the building interior and is directed through the frame structure. In this way, the frame structure can contribute as a shutter to the effect that similar conditions are prevailing to the greatest possible extent in recording approaching cats. This in turn can contribute to a particularly high hit rate in the determination of whether the cat is carrying a prey animal in its mouth.

Exemplary embodiments of the invention further comprise an RFID-controlled cat flap, comprising: a mounting device by means of which the RFID-controlled cat flap can be mounted to a building wall and/or to a building door and/or to a building window; a door element that is pivotable with respect to the mounting device; a closing mechanism that selectively enables an opening of the pivotable door element; an RFID-based control which is configured to communicate with an RFID tag worn by a cat approaching the RFID-controlled cat flap and which is configured to cause the closing mechanism to enable an opening of the pivotable door element, when it detects an approved RFID tag; and a supplementary access control system according to any of the preceding embodiments. The additional features, modifications and effects, as described above with respect to the supplementary access control system, can be applied analogously to the RFID-controlled cat flap comprising such a supplementary access control system.

According to a further embodiment, the supplementary access control system is integrated into the RFID-controlled cat flap. The components of the supplementary access control system, for example, can be mechanically embedded in the architecture of the RFID-controlled cat flap. The RFID-controlled cat flap and the supplementary access control system can also share a common power supply.

According to an alternative embodiment, the supplementary access control system is designed as a stand-alone/independent system and is arranged with respect to the RFID-based control such that the camera of the supplementary access control system is capable of recording the at least one image of the cat approaching the RFID-controlled cat flap. The supplementary access control system is also regarded as an independent system if a releasable mechanical connection, such as e.g. a clip connection is present between the RFID-controlled cat flap and the supplementary access control system.

Exemplary embodiments of the invention further comprise a method for supplementary control of access through an RFID-controlled cat flap, wherein the RFID-controlled cat flap is configured to communicate with an RFID tag worn by a cat approaching the RFID-controlled cat flap, and to selectively enable an opening of the RFID-controlled cat flap, the method comprising the following steps: detecting a cat approaching the RFID-controlled cat flap; on the basis of the detection of the cat approaching the RFID-controlled cat flap, emitting a radio-frequency interfering signal which is suitable to prevent an opening of the RFID-controlled cat flap; recording at least one image of the cat approaching the RFID-controlled cat flap; on the basis of the at least one image, determining whether the cat is carrying a prey animal in its mouth; and on the basis of the determination that the cat is not carrying a prey animal in its mouth, terminating the emission of the radio frequency interfering signal. The steps mentioned can be executed in the stated sequence or in any other sensible sequence or, if sensibly possible, in parallel. The additional features, modifications and effects, as described above with respect to the supplementary access control system, are applicable analogously to the method for supplementary control of access through an RFID-controlled cat flap.

Exemplary embodiments of the invention furthermore comprise a computer program/a computer program product which contains program instructions which, when executed on a computer-aided device, cause the following steps: providing a graphical user interface; on the graphical user interface, presenting at least one image of an approaching cat that has been recorded by a camera of a supplementary access control system for an RFID-controlled cat flap or by a camera of an RFID-controlled cat flap; on the graphical user interface, presenting a determination of an image processing unit of the supplementary access control system or representing a determination of an image processing unit of the supplementary access control system or presenting a determination of an image processing unit of the RFID-controlled cat flap as to whether the cat in the at least one image is carrying a prey animal in its mouth; receiving a user input, wherein the user input comprises a user indication of whether the cat in the at least one image is carrying a prey animal in its mouth, or wherein the user input comprises a user indication of whether the determination of the image processing unit is correct; and providing the user indication to train the image processing unit with an extended data base. By means of the computer program or computer program product, user feedback can be conveniently and efficiently collected as to whether the determinations of the image processing unit with respect to the prey animal in the mouth of the cat is correct. In particular, incorrect determinations of the image processing unit can be easily and efficiently identified. With the aid of the feedback, the hit rate of the image processing unit can be improved for the future. For example, when a certain number of user indications is present, renewed training of the image processing unit can be carried out.

The user indications may originate from one user or from a plurality of users making use of a plurality of identical/similar computer programs/computer program products, for a new training process. The supplementary access control system for the RFID-controlled cat flap may be a supplementary access control system according to any of the embodiments of the invention described above. The RFID-controlled cat flap may be an RFID-controlled cat flap according to any of the embodiments of the invention described above.

The computer program or computer program product is designed for execution on a computer-aided device. The computer-aided device may be a user terminal, such as e.g. a smartphone, tablet, laptop, or PC. It is also possible that the computer program is executed on a server, such as e.g. a cloud server, and that a user has access to the computer program or the graphical user interface of the computer program via a web interface, such as e.g. a browser.

The at least one image of the approaching cat and the determination of the image processing unit can be displayed jointly. The determination of the image processing unit as to whether the cat is carrying a prey animal in its mouth can be indicated in the form of text or by means of a color coding, e.g. with green for no prey in the mouth and red for prey in the mouth, or in any other suitable manner. Receiving the user input can take place via corresponding buttons in the graphical user interface, which the user can click on or select via a touch screen, for example. Before presenting the at least one image of the approaching cat and the determination by the image processing unit, the corresponding data may have been received from the supplementary access control system or from the RFID-controlled cat flap, respectively.

Providing the user indication to train the image processing unit with an extended data base may include providing the user indication to an external data processing means, such as e.g. an external server in the cloud. On the external server, an updated version of the image processing unit or an updated version of parts of the image processing unit can be created with the aid of the feedback data. The updated version of the image processing unit or the updated version of parts of the image processing unit can be entered into the supplementary access control system or the RFID-controlled cat flap as an update. In particular, an artificial intelligence can be newly trained on the external server with inclusion of the feedback data, and the result of this new training run can be entered into the image processing unit of the supplementary access control system or the RFID-controlled cat flap.

Exemplary embodiments of the invention further comprise a supplementary access control system for an RFID-controlled cat flap, comprising: a sensor for detecting an approaching cat and a camera for recording at least one image of the approaching cat; an image processing unit that is coupled to the camera and configured to determine, on the basis of the at least one image, whether the cat is a predefined, particular cat; a radio-frequency signal generator configured to transmit an identification signal, wherein the identification signal is suitable to enable an opening of the RFID-controlled cat flap; and a control unit coupled to the sensor, to the image processing unit and to the radio-frequency signal generator, wherein the control unit, on the basis of the determination of the image processing unit that the cat is the predefined particular cat, is configured to cause the radio frequency generator to transmit the identification signal.

Exemplary embodiments of the invention allow for emulating an RFID tag that allows access through the RFID-controlled cat flap. Thus, exemplary embodiments of the invention may enable an extension of the selective opening functionality of an RFID-controlled cat flap to cats which have neither implanted an RFID tag nor wear an RFID tag in a different way, for example in a collar. In this case, no manipulations have to be performed on the technical system of RFID-controlled cat flap and RFID tag worn by the cat. Existing RFID-controlled cat flaps can be supplemented very conveniently by the functionality that access-authorized cats, which do not wear an RFID tag, can be granted access. The possibly undesired implantation of RFID tags or the wearing of an RFID tag in a collar, which is subject to the risk of loss, can be avoided.

In such embodiments, the radio-frequency signal generator is configured to transmit an identification signal that is suitable to enable opening of the RFID-controlled cat flap. In other words, the radio-frequency signal generator is configured to transmit an identification signal which encodes an identity stored in the RFID-controlled cat flap as having an access authorization. For this purpose, the RFID-controlled cat flap may have been pre-programmed with a corresponding identity. It is also possible for the radio-frequency signal generator to be configured to transmit an identification signal with a master identity of the RFID-controlled cat flap.

The additional features, modifications and effects, as described above with respect to the supplementary access control system for analysis with respect to a prey animal in the mouth of the cat, are applicable analogously for the supplementary access control system for analysis with respect to a predefined particular cat.

According to a further embodiment, the image processing unit is configured to analyze the at least one image with an artificial intelligence as to whether the cat is the predefined, particular cat.

According to a further embodiment, the artificial intelligence comprises a neural network, in particular a convolutional neural network.

According to a further embodiment, the artificial intelligence is a pre-trained artificial intelligence, wherein the artificial intelligence has in particular been trained with at least 200 images of the predefined particular cat and at least 200 images of other cats, which are correspondingly annotated. In particular, by training with between 200 and 500 images of the predefined particular cat, there can already be achieved a very good basic robustness of the artificial intelligence. The number of images of other cats may, but need not be many times higher. By creating corresponding databases during operation of a plurality of supplementary access control systems, it is possible relatively quickly to create a broad data base for the images of other cats. The broad data base of images of other cats may be included in the artificial intelligence training with respect to the predefined particular cat. After training with the indicated numbers of images of the predefined particular cat and other cats, it may be possible with respect to the determination as to whether the cat is the predefined particular cat, to achieve a hit rate of more than 95%, in particular a hit rate of more than 99%, in a new image to be analyzed.

Exemplary embodiments of the invention further comprise an RFID-controlled cat flap, comprising: a mounting device by means of which the RFID-controlled cat flap can be mounted to a building wall and/or to a building door and/or to a building window; a door element that is pivotable with respect to the mounting device; a closing mechanism that selectively enables an opening of the pivotable door element; an RFID-based control that is configured to communicate with an RFID tag worn by a cat approaching the RFID-controlled cat flap and that is configured to cause the closing mechanism to enable an opening of the pivotable door element when it detects an approved RFID tag; and a supplementary access control system according to any of the preceding embodiments. The additional features, modifications and effects, as described above with respect to the supplementary access control system, are applicable analogously to the RFID-controlled cat flap comprising such a supplementary access control system.

According to a further embodiment, the supplementary access control system is integrated into the RFID-controlled cat flap.

According to an alternative embodiment, the supplementary access control system is designed as an independent system and is arranged in relation to the RFID-based control such that the camera of the supplementary access control system is capable of recording the at least one image of the cat approaching the RFID-controlled cat flap.

Exemplary embodiments of the invention further comprise a method for supplementary control of access through an RFID-controlled cat flap, wherein the RFID-controlled cat flap is configured to communicate with an RFID tag worn by a cat approaching the RFID-controlled cat flap, and to selectively enable an opening of the RFID-controlled cat flap, the method comprising: detecting a cat approaching the RFID-controlled cat flap; recording at least one image of the cat approaching the RFID-controlled cat flap; on the basis of the at least one image, determining whether the cat is a predefined, particular cat; and on the basis of the determination that the cat is a predefined, particular cat, emitting an identification signal suitable to enable an opening of the RFID-controlled cat flap. The steps mentioned can be carried out in the order indicated or in any other sensible order or, if sensibly possible, in parallel. The additional features, modifications and effects, as described above with respect to the supplementary access control system, are applicable analogously to the method for supplementary control of access through an RFID-controlled cat flap.

Exemplary embodiments of the invention further comprise a computer program/a computer program product which contains program instructions which, when executed on a computer-aided device, cause the following steps: providing a graphical user interface; on the graphical user interface, presenting at least one image of an approaching cat, which has been recorded by a camera of a supplementary access control system for an RFID-controlled cat flap or by a camera of an RFID-controlled cat flap; on the graphical user interface, presenting a determination of an image processing unit of the supplementary access control system or presenting a determination of an image processing unit of the RFID-controlled cat flap as to whether the cat in the at least one image is a predefined particular cat; receiving a user input, wherein the user input comprises a user indication as to whether the cat in the at least one image is the predefined particular cat, or wherein the user input comprises a user indication as to whether the determination of the image processing unit is correct; and providing the user indication to train the image processing unit with an extended data base. By means of the computer program or the computer program product, user feedback as to whether the determinations of the image processing unit with respect to the predefined particular cat are correct, can be conveniently and efficiently collected. In particular, incorrect determinations of the image processing unit can be easily and efficiently identified. With the aid of the feedback, the hit rate of the image processing unit can be improved for the future. For example, when a certain number of user indications is present, renewed training of the image processing unit can be carried out. In this regard, the user indications can originate from the user whose supplementary access control system or RFID-controlled cat flap regulates the access for the predefined particular cat. The images from other users, whose supplementary access control system or RFID-controlled cat flap regulates access for other cats and that make use of the same/similar computer programs/computer program products, may be used as additional images of other cats for renewed training. The supplementary access control system for the RFID-controlled cat flap may be a supplementary access control system according to any of the above-described embodiments of the invention. The RFID-controlled cat flap may be an RFID-controlled cat flap according to any of the above-described embodiments of the invention.

The computer program or computer program product is designed for execution on a computer-aided device. The computer-aided device may be a user terminal, such as e.g. a smartphone, tablet, laptop, or PC. It is also possible that the computer program is carried out on a server, such as e.g. a cloud server, and that a user has access to the computer program or to the graphical user interface of the computer program via a web interface, such as a browser, for example.

The at least one image of the approaching cat and the determination of the image processing unit can be displayed jointly. The determination of the image processing unit as to whether the cat is the predefined particular cat can be indicated as text or via a color coding, for example with green for the predefined, particular cat and red for other cats, or in any other suitable manner. The user input can be received via corresponding buttons in the graphical user interface, which the user e.g. can click on or select via a touch screen. Prior to presenting the at least one image of the approaching cat and the determination by the image processing unit, the corresponding data may have been received from the supplementary access control system or from the RFID-controlled cat flap.

Providing the user indication to train the image processing unit with an extended data base may include providing the user indication to an external data processing means, such as e.g. an external server in the cloud. On the external server, an updated version of the image processing unit or an updated version of parts of the image processing unit may be created with the aid of the feedback data. The updated version of the image processing unit or the updated version of parts of the image processing unit can be entered into the supplementary access control system or the RFID-controlled cat flap as an update. In particular, an artificial intelligence can be newly trained on the external server with inclusion of the feedback data, and the result of this new training run can be entered into the image processing unit of the supplementary access control system or of the RFID-controlled cat flap.

The computer program or computer program product can be provided not only for collecting user feedback for the renewed training of the image processing unit. It is also possible that the computer program or computer program product is designed for composing annotated images for the initial training of the image processing unit. Expressed in the terms of a claim, exemplary embodiments of the invention further comprise a computer program/a computer program product which contains program instructions which, when executed on a computer-aided device, cause the following steps: providing a graphical user interface; on the graphical user interface, presenting at least one image of an approaching cat, which has been recorded by a camera of a supplementary access control system for an RFID-controlled cat flap or by a camera of an RFID-controlled cat flap; receiving a user input, wherein the user input comprises a user indication as to whether the cat in the at least one image is the predefined particular cat; and providing the user indication for initial training of the image processing unit. The additional features, modifications and effects described above with respect to the renewed training of the image processing unit are applicable analogously to the initial training. The images of other cats can be procured for initial training from a database. The database may include, in particular, images from other users using the same/similar computer programs/computer program products. In this way, after a supplementary access control system for an RFID-controlled cat flap or an RFID-controlled cat flap has been put into operation, it is possible to quite quickly obtain a data base which enables a high hit rate with respect to the determination as to whether the cat is a predefined particular cat.

In the embodiments set forth so far, the aspects of the determination as to whether the cat is carrying a prey animal in its mouth, and the determination as to whether the cat is a predefined particular cat, have been described separately. However, it is possible for the two aspects to be implemented jointly. In particular, it is possible and expressly disclosed herewith that supplementary access control systems, RFID-controlled cat flaps and methods for supplementary control of access through an RFID-controlled cat flap according to exemplary embodiments of the invention comprise features of both aspects. Further in particular, it is possible that the same or different sub-combinations of features of both aspects are realized in the supplementary access control systems, RFID-controlled cat flaps and methods for supplementary control of access through an RFID-controlled cat flap.

Furthermore, it is herewith emphasized and expressly disclosed that the aspect of the determination as to whether the cat is a predefined particular cat, represents an invention independently of the implementation of the cat flap as an RFID-controlled cat flap, and independently of the implementation of a supplementary access control system. In other words, the aspect of determining whether a cat approaching the cat flap is a predefined particular cat, and of controlling the cat flap on the basis of this determination is considered to be an independent invention. Expressed in the terms of a claim, exemplary embodiments of the invention comprise a cat flap comprising: a mounting device by means of which the cat flap can be mounted to a building wall and/or to a building door and/or to a building window; a door element that is pivotable with respect to the mounting device; a closing mechanism that selectively enables an opening of the pivotable door element; a sensor for detecting an approaching cat and a camera for recording at least one image of the approaching cat; an image processing unit that is coupled to the camera and that is configured to determine, on the basis of the at least one image, whether the cat is a predefined particular cat; and a control unit that is coupled to the sensor and to the image processing unit, wherein the control unit is configured, on the basis of the determination of the image processing unit that the cat is the predefined particular cat, to cause the closing mechanism to enable an opening of the pivotable door element. The additional features, modifications and effects, as described above with respect to the supplementary access control system and with respect to the RFID-controlled cat flap, are applicable analogously to such a cat flap, to the extent that this is expedient. Also a corresponding method for operating a cat flap is expressly disclosed herewith.

### BRIEF DESCRIPTION OF THE DRAWINGS

Further exemplary embodiments of the invention will be described in the following with reference to the attached drawings.

FIG. 1 shows an RFID-controlled cat flap, with which a supplementary access control system according to an exemplary embodiment of the invention can cooperate or into which a supplementary access control system according to an exemplary embodiment of the invention can be integrated, partially in a schematic cross-sectional view and partially as a block diagram.

FIG. 2 shows a supplementary access control system according to an exemplary embodiment of the invention in a schematic perspective view.

FIG. 3 shows a supplementary access control system according to an exemplary embodiment of the invention in a block diagram.

FIG. 4 illustrates the operation of a supplementary access control system according to an exemplary embodiment of the invention by way of a flowchart.

FIG. 5 shows two exemplary images of a cat without a prey animal in the mouth and the same cat with a prey animal in the mouth, as they can be taken and processed in a supplementary access control system according to an exemplary embodiment of the invention.

FIG. 6 illustrates the operation of a supplementary access control system according to an exemplary embodiment of the invention by way of a flowchart.

FIG. 7 shows two exemplary images of two different cats as they may be taken and processed by a supplementary access control system according to an exemplary embodiment of the invention.

### DETAILED DESCRIPTION

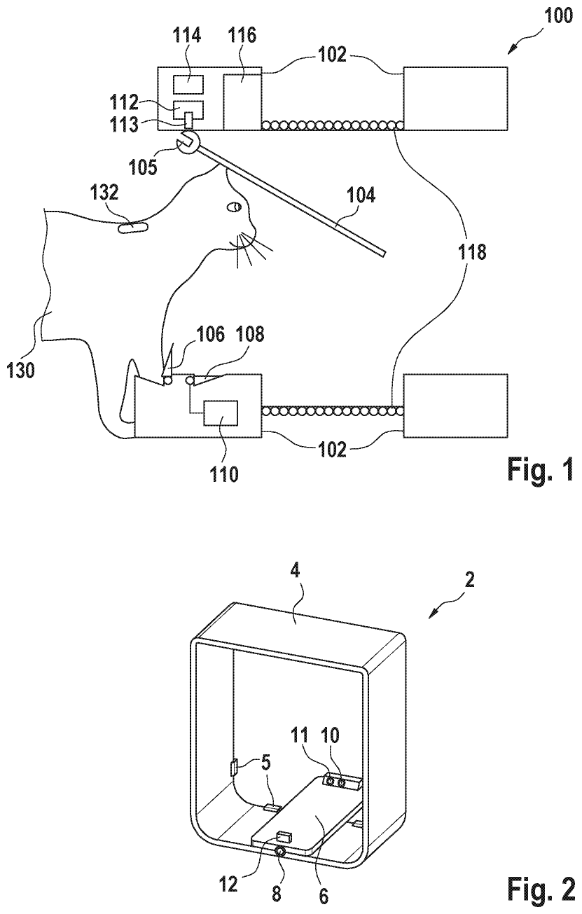

FIG. 1 shows an RFID-controlled cat flap 100 according to an exemplary embodiment, partially in a schematic cross-sectional view and partially as a block diagram. The RFID-controlled cat flap 100 may be provided with a supplementary access control system according to an exemplary embodiment of the invention or cooperate with a supplementary access control system according to an exemplary embodiment of the invention. The RFID-controlled cat flap 100 can thus be regarded as a starting point for the extension with the supplementary access control system according to exemplary embodiments of the invention.

The RFID-controlled cat flap 100 comprises a frame structure 102, which is shown in cross section in FIG. 1. The frame structure 102 forms a passage/tunnel, through which a cat 130 can enter a building, such as e.g. a home, and exit the building. FIG. 1 shows a situation in which the cat 130 is about to enter the building from the outside through the tunnel formed by the frame structure 102. The frame structure 102 can be introduced into a corresponding opening in a house door or into a corresponding opening of another building area.

The RFID-controlled cat flap 100 has a pivotable door element 104. If the pivotable door element 104 is not locked, the cat 130 may push it open with its snout/head and gain access to the building. The pivotable door element 104 is dimensioned substantially such that it completely closes the tunnel through the frame structure 102.

In the exemplary embodiment of FIG. 1, the RFID-controlled cat flap has a closing mechanism which is composed of a plurality of components.

On the one hand, the closing mechanism has a first pivotable stop 106 and a second pivotable stop 108, wherein the second pivotable stop 108 is movable by an actuator 110 and/or can be fixed in its upright position by means of the actuator 110. The first pivotable stop 106 and the second pivotable stop 108 are arranged on the frame structure 102 in a region in which the lower end of the pivotable door element 104 is positioned, when the pivotable door element 104 is in its equilibrium position. When entering the building, the cat 130 can bring the second pivotable stop 108 into a lying position with the aid of the pivotable door element 104, provided that the second pivotable stop 108 is not fixed in its upright position. When exiting the building, the cat 130 can move the first pivotable stop 106 into a lying position with the aid of the pivotable door element 104. In a closed state, the lower end portion of the pivotable door element 104 is arranged between the first pivotable stop 106 and the second pivotable stop 108.

On the other hand, the closing mechanism comprises a locking pin 113 which is arranged in an upper portion of the frame structure 102 above the pivotable door element 104 and, by means of an actuator 112, can be inserted into, and extracted from, a corresponding recess 105 in the upper portion of the pivotable door element 104.

With the aid of the locking pin 113 and the second pivotable stop 108, which can be fixed in the upright position, the pivotable door element 104 can be fixed in the closed position. In other words, the RFID-controlled cat flap 100 is capable of selectively enabling and preventing opening of the pivotable door element, respectively.

It is emphasized that the closing or locking mechanism described above is purely exemplary. Any other suitable type of closing mechanism may be provided. It is also possible that locking takes place only with the aid of the locking pin 113 or with the aid of the second pivotable stop 108.

The RFID-controlled cat flap 100 may be configured to be generally closed, i.e. that the locking pin 113 is inserted into the recess 105 and the second pivotable stop 108 is fixed in the upright position. The selective opening of the pivotable door element 104 is rendered possible during operation by an identification of the cat 130 and release of the closing or locking mechanism. The identification of the cat 130 takes place as follows.

In the exemplary embodiment of FIG. 1, the cat 130 has implanted an RFID tag 132, also referred to as RFID chip. It is understood that the RFID tag may also be part of a collar of the cat 130. When the cat 130 approaches the RFID-controlled cat flap 100, a control unit 116 of the RFID-controlled cat flap 100 initiates communication with the RFID tag 132. For this purpose, the RFID-controlled cat flap 100 comprises a coil 118. The coil 118 is wound about a central portion of the frame structure 102 and acts as an antenna on the part of the RFID-controlled cat flap 100 for communication with the RFID tag 132. The control unit 116 and the RFID tag 132 communicate by means of a suitable protocol for reading out the identification information stored in the RFID tag 132. The read-out identification information is compared with those data that are stored in the control unit 116 for access-authorized cats. When the control unit 116 identifies the cat 130 as authorized to access, it causes the actuator 110 and the actuator 112 to release the second pivotable stop 108 and to retract the locking pin 113. As a result, the cat 130 can open the pivotable door element 104 and enter the building.

The RFID-controlled cat flap 100 further comprises a power supply 114, supplying electrical energy to the control unit 116 and the actuators 110, 112. The power supply 114 may be a local power supply, such as a rechargeable battery, or a power terminal to a domestic outlet, or any other suitable type of electrical energy supply.

FIG. 2 shows a supplementary access control system 2 for an RFID-controlled cat flap, such as e.g. for the RFID-controlled cat flap 100 of FIG. 1, in a schematic perspective view. The supplementary access control system 2 has a frame structure 4. The frame structure 4 can be attached to the frame structure of an existing RFID-controlled cat flap via clip connections 5, such as e.g. to the frame structure 102 of the RFID-controlled cat flap 100 of FIG. 1. Thus, the frame structure 4 of the supplementary access control system 2 can form an extension of the tunnel, through which a cat passes when entering a building or leaving a building.

An electronics housing 6, which contains various components of the supplementary access control system 2 described in detail below, is arranged in the lower portion of the frame structure 4 of the supplementary access control system 2. A sensor 8 for detecting an approaching cat is arranged on the outwardly directed end face of the electronics housing 6. The sensor 8 can be a passive infrared sensor. Furthermore, an additional distance sensor 12 is provided on the upper side of the electronics housing 6, close to the end face of the electronics housing 6.

In the exemplary embodiment of FIG. 2, the additional distance sensor is directed upward and has an IR light source, such as e.g. an IR LED, and an IR photosensor, such as e.g. an IR photodiode. The additional distance sensor 12, via the emission of IR light by means of the IR light source and the evaluation of the measured values of the IR photosensor, can provide an indication as to whether the approaching cat is located at least with part of its body in the frame structure 4. A cat located in the frame structure 4 significantly reflects IR light, which is noticeable in the measured values of the IR photosensor. The additional distance sensor can act as a kind of light barrier, which provides an indication of how far the cat has already approached the supplementary access control system 2 and, respectively, whether the cat is still located at/in the supplementary access control system 2.

On the side of the electronics housing 6 facing the building interior, there is provided a structure having a camera 10 and a light source 11 integrated therein. The camera 10 and the light source 11 are directed obliquely upwards. In this way, the camera 10 and the light source 11 are directed towards the area in which the head of an approaching cat is expected when it is in the course of entering the building through the frame structure 4 of the supplementary access control system 2. The camera 10 is a digital camera. The light source 11 is provided for illumination of the approaching cat and can be implemented e.g. as LED. The functional linking of the described components of the supplementary access control system 2 and their interaction during operation will be described with reference to the following figures.

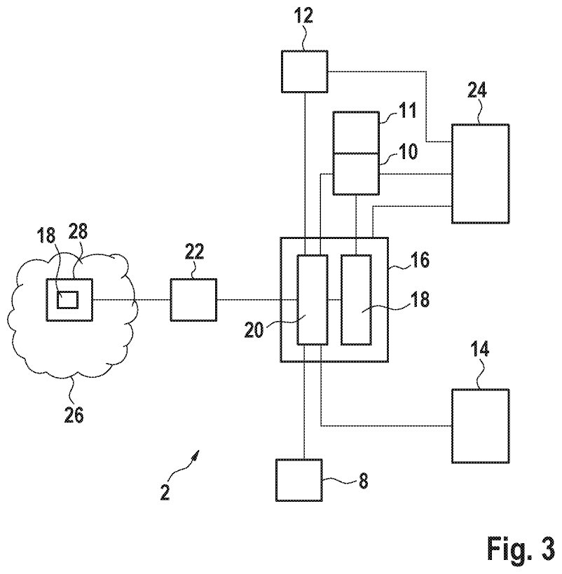

FIG. 3 shows a supplementary access control system 2 according to an exemplary embodiment of the invention in a block diagram. The local components of the supplementary access control system 2 may be arranged in the device structure shown in FIG. 2. However, it is also possible that the components of the supplementary access control system 2 shown in FIG. 3 are arranged in any another suitable way.

The sensor 8, the camera 10 with the light source 11, and the additional distance sensor 12 are connected to a microcontroller 16. In the exemplary arrangement of FIG. 2, the microcontroller 16 can be accommodated in the electronics housing 6. In the exemplary embodiment of FIG. 3, a part of an image processing unit 18 and a control unit 20 are implemented on the microcontroller 16.

The microcontroller 16 is connected furthermore to a radio-frequency signal generator 14. The radio-frequency signal generator 14 is designed to transmit an interfering signal, which is suitable for disturbing or interfering with the communication between an RFID-controlled cat flap and an RFID tag worn by a cat in such a way that no identification of the cat by the RFID-controlled cat flap is possible. The radio-frequency signal generator 14 may comprise a resonant circuit having one or more capacitances and one or more inductors. The one or more inductors can serve as antennas for emitting the interfering signal. In the exemplary arrangement of FIG. 2, the one or more capacitances, which may be capacitors, may be arranged in the electronics housing 6, and the one or more inductors may be coils, which in the frame structure 4 extend around the passage area for the cat. This coil or these coils act as antenna for the emission of the interfering signal, similar to the coil 118 shown in FIG. 1, which is provided as an antenna of the RFID-controlled cat flap 100 for communication with the RFID tag 132. It is also possible for the one or more capacitances or capacitors and the one or more inductors or coils to be accommodated in the electronics housing 6.

In addition or as an alternative to the ability of the radio-frequency signal generator 14 to emit or transmit the interfering signal described above, the radio-frequency signal generator 14 may be configured to transmit an identification signal which is suitable to enable an opening of the RFID-controlled cat flap.

The microcontroller 16 is further connected to a network connection 22. The network connection 22 can in particular be a wireless network connection, such as e. g a WLAN connection. Via the network connection 22, the microcontroller 16 is connected to external data processing devices, represented here as part of a cloud 26. Via the network connection 22, the microcontroller 16 may exchange data with external entities, such as e.g. with a remote server 28 and/or with monitoring and control programs, such as smart phone apps or tablet apps. In the exemplary embodiment of FIG. 3, part of the image processing unit 18 is implemented in the remote server 28.

The supplementary access control system 2 further includes an internal power supply 24. The internal power supply 24 supplies electrical energy to the camera 10, the light source 11, the additional distance sensor 12, the microcontroller 16, and, if appropriate, the radio-frequency signal generator 14 and the network connection 22. The internal power supply 24 may be a rechargeable battery or a power terminal to a domestic outlet or any other suitable type of electrical energy supply.

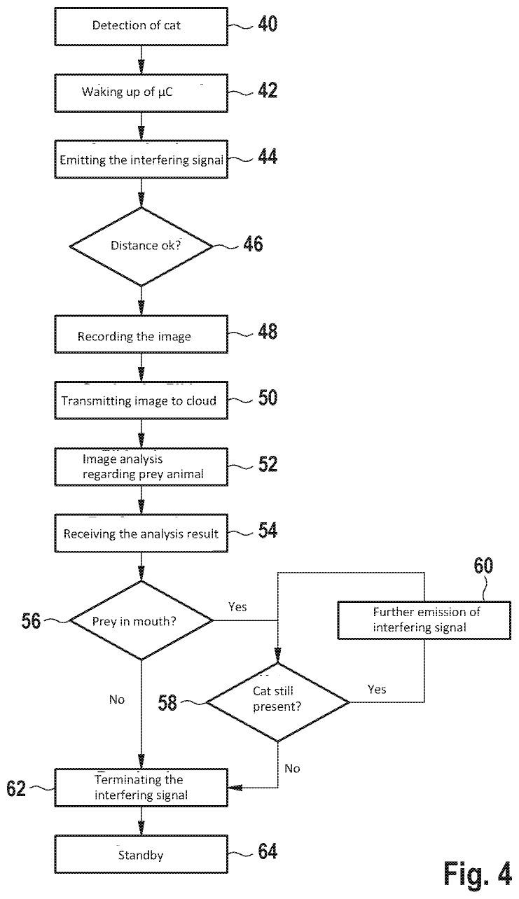

In the exemplary embodiment of FIG. 3, the image processing unit 18 is partially implemented on the microcontroller 16 and partially on the remote server 28. However, it is also possible for the image processing unit 18 to be implemented completely on the microcontroller 16 or completely in the cloud 26. In the case that part of the image processing unit or the entire image processing unit is implemented in the cloud 26, the supplementary access control system is a distributed system. In such a distributed system, part of the components of the supplementary access control system 2, namely the components shown in the block diagram of FIG. 3 to the right of the network connection 22, are arranged locally in the device structure shown in FIG. 2, whereas other components are implemented remotely from the device structure shown in FIG. 2, such as e.g. in the cloud 26. The interaction and cooperation of the components of the supplementary access control system 2 of FIG. 3 will be described below with reference to the flowchart of FIG. 4.

FIG. 4 shows a flowchart illustrating the operation of a supplementary access control system 2 according to an exemplary embodiment of the invention, in particular the operation of the supplementary access control system 2 of FIG. 2, by way of an exemplary run of the procedure.

In step 40, the sensor 8 detects a cat approaching the supplementary access control system 2. On the basis of this detection, the sensor 8 transmits a signal to the microcontroller 16, which transfers the same from a standby state to an operating state. This can also be referred to as waking up of the microcontroller 16, illustrated as step 42. On the basis of the knowledge about the presence of a cat, the control unit 20 of the microcontroller 16 causes the radio-frequency signal generator 14 to emit the interfering signal. This is summarized in FIG. 4 in step 44 as emitting the interfering signal.

In step 46, the additional distance sensor 12 monitors whether the approaching cat is located in the frame structure 4 and thus the distance of the approaching cat to the camera 10 is in a suitable range. As soon as the distance is suitable for recording one or more images, the control unit 20, which continuously receives an indication regarding the distance of the cat from the additional distance sensor 12, transmits a trigger signal to the camera 10. The at least one image of the cat is then recorded by the camera 10 in step 48. The trigger signal of the control unit can also be transferred to the light source 11 or passed from the camera 10 to the light source 11. The light source 11, in response to the trigger signal, can switch on the illumination of the cat. It is also possible that such an illumination takes place only if required by the ambient light conditions. The camera 10 can be equipped with a corresponding sensor system and logic and control the light source 11 accordingly.

In step 50, the image recorded of the cat is sent to the external server 28 in the cloud 26 via the network connection 22. In step 52, the image analysis regarding the question of whether or not the approaching cat is carrying a prey animal in its mouth, is carried out in the part of the image processing unit 18 that is implemented on the external server 28 in the cloud 26. As described above, the image processing unit 18 may also be completely implemented locally in the microcontroller 16. In other words, step 52 may be performed both in the cloud 26 and locally in the microcontroller 16. Accordingly, step 50, i.e. transmitting the image via the network connection 22, either may take place or be omitted.

In step 52, the image processing unit determines whether the cat according to the captured image is carrying a prey animal in its mouth. The determination is made by means of artificial intelligence. In particular, the image processing unit analyzes, by means of a pre-trained neural network, whether the cat is carrying a prey animal in its mouth. In this regard, the neural network, which has been trained with correspondingly annotated images of cats without prey animals in the mouth and cats with prey animals in the mouth, arrives at a result as to whether or not the cat is carrying a prey animal in its mouth. The result may be a yes/no decision, or may represent a probability value whether the cat is carrying a prey animal in its mouth, or may be in a different suitable form. The part of the image processing unit 18 implemented on the server in the cloud 26 transmits the result of the image analysis back to the microcontroller 16 via the network connection 22.

In step 54, the control unit 20 of the microcontroller 16 receives the determination as to whether the cat is carrying a prey animal in its mouth, via the network connection 22. On the basis of this determination, the control unit 20 makes a decision in step 56. If it has been determined that the cat is carrying a prey animal in its mouth, it is continuously monitored in step 58 by means of the additional distance sensor 12 whether the cat is still present in the vicinity of the supplementary access control system 2. If so, the control unit 20 ensures that the radio-frequency signal generator 14 continues to emit the interfering signal. This is illustrated in step 60. If it is determined by means of the additional distance sensor 12 in step 58 that the cat is no longer present in the vicinity of the supplementary access control system 2, the control unit 20, in step 62, causes the radio-frequency signal generator 14 to terminate the transmission of the interfering signal. The control unit 20 also causes the radio-frequency signal generator 14 to terminate the transmission of the interfering signal, if it has been determined in step 56 that the cat is not carrying a prey animal in its mouth.

There are two different facts achieved by the two different paths between step 56 and step 62. On the one hand, the emission of the interfering signal is terminated when the cat is not carrying a prey animal in its mouth, so that the cat can enter the building through the RFID-controlled cat flap. On the other hand, on the basis of the determination that the cat is carrying a prey animal in its mouth, the interfering signal is emitted until the cat has moved away from the supplementary access control system, so that entry into the building with the prey animal in the mouth is prevented.

After termination of the interfering signal in step 62, the supplementary access control system 2, in particular the microcontroller 16, enters a standby state in step 64. The supplementary access control system 2 wakes up from this standby state during the next detection of an approaching cat by means of the sensor 8, as described above with reference to step 40.

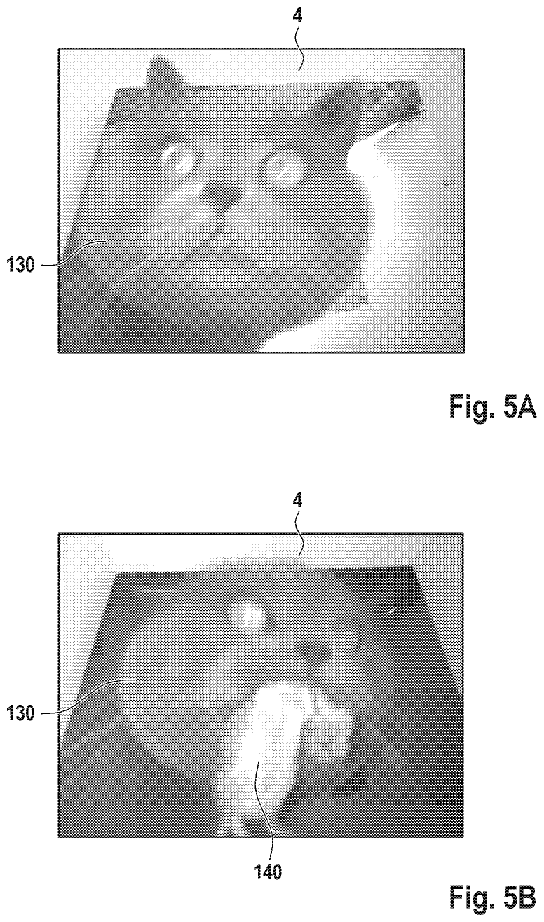

FIG. 5 shows two exemplary images of a cat without a prey animal in the mouth and the same cat with a prey animal in the mouth, as these can be recorded and processed in a supplementary access control system according to an exemplary embodiment of the invention.

FIG. 5A shows an image of a cat 130 without a prey animal in the mouth. The head of the cat 130 in the image shown is enclosed by the frame structure 4 of a supplementary access control system 2, as shown e.g. in FIG. 2. Between the head of the cat 130 and the frame structure 4, a section of the surroundings of the supplementary access control system 2 can be seen as an image background.

FIG. 5B shows an image of the same cat 130 as in FIG. 5A, but with a prey animal in the mouth. In the image of FIG. 5B, the cat 130 has a mouse 140 in its mouth. Again, the head of the cat 130 in the image shown is enclosed by the frame structure 4, and a section of the surroundings of the supplementary access control system 2 can be seen as an image background.

As can be seen from the comparison of the images of FIGS. 5A and 5B, images recorded by the camera 10 of a supplementary access control system 2 can differ in many respects, such as e.g. in the illumination, in the viewing direction of the cat 130, in the blur of the image, in the brightness of the background, etc. Despite this multiplicity of degrees of freedom in the image composition, it has been found that an artificial intelligence that has been trained with approx. 1000 images of cats without a prey animal in the mouth and approx. 1000 images of cats with a prey animal in the mouth, can reach a hit rate of greater than 95% or even greater than 99% in the analysis of newly recorded images with respect to the determination as to whether the cat is carrying a prey animal in the mouth.

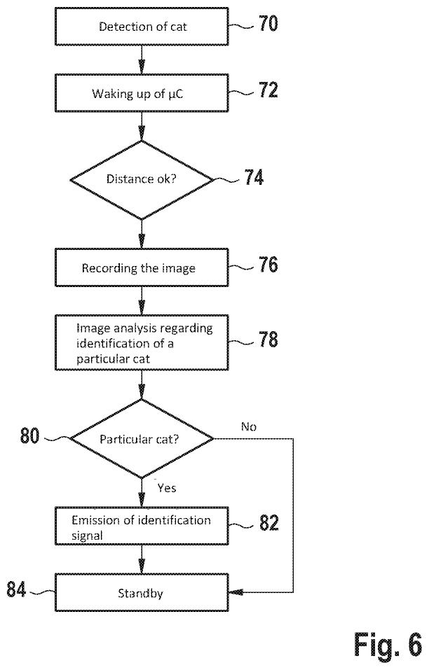

FIG. 6 shows a flowchart illustrating the operation of a supplementary access control system 2 according to an exemplary embodiment of the invention, in particular the operation of the supplementary access control system 2 of FIG. 3, by way of an exemplary run of the procedure. Some steps of the flowchart of FIG. 6 are analogous to the corresponding steps of the flowchart of FIG. 4. These steps will be described again below; however, reference is additionally made to the description of FIG. 4.

In step 70, the sensor 8 detects a cat approaching the supplementary access control system 2. On the basis of this detection, the sensor 8 transmits a signal to the microcontroller 16, which transfers the same from a standby state to an operating state. This can also be referred to as waking up of the microcontroller 16, illustrated as step 72.

In step 74, the additional distance sensor 12 monitors whether the approaching cat is located in the frame structure 4 and thus the distance of the approaching cat to the camera 10 is in a suitable range. As soon as the distance for recording one or more images is suitable, the control unit 20, which continuously receives an indication of the distance of the cat from the additional distance sensor 12, transmits a trigger signal to the camera 10. The at least one image of the cat is then recorded by the camera 10 in step 76. The trigger signal of the control unit can also be transferred to the light source 11 or passed from the camera 10 to the light source 11. The light source 11 can turn on the illumination of the cat in response to the trigger signal. It is also possible that such an illumination takes place only if required by the ambient light conditions. The camera 10 can be equipped with a corresponding sensor system and logic and can control the light source 11 accordingly.

In step 78, the image analysis regarding the question as to whether the approaching cat is a predefined particular cat is performed in the part of the image processing unit 18 that is implemented locally in the microcontroller 16. It is also possible that step 78 is performed in the part of the image processing unit 18 in the cloud 26, e.g. in the part of the image processing unit 18 that is implemented on an external server 28. To this end, before the step 78 is performed, the image recorded of the cat would be sent to the external server 28 in the cloud 26 via the network connection 22. In other words, step 78 may be performed both in the cloud 26 and locally in the microcontroller 16.

In step 78, the image processing unit determines whether the cat according to the recorded image is a predefined particular cat.

The determination is made by means of artificial intelligence. In particular, the image processing unit analyzes, by means of a pre-trained neural network, whether the cat according to the recorded image is a predefined particular cat. The neural network, which has been trained with correspondingly annotated images of the predefined, particular cat and images of other cats, arrives at a result as to whether the cat according to the recorded image is the predefined, particular cat. The result may be a yes/no decision or may represent a probability value as to whether the cat is the predefined, particular cat, or may be in a different suitable form. If step 78 is implemented in the cloud 26, the part of the image processing unit 18 implemented on the server in the cloud 26 transmits the result of the image analysis back towards the microcontroller 16 via the network connection 22.

In step 80, the control unit 20 of the microcontroller 16 receives the determination as to whether the cat is the predefined, particular cat. If it has been determined that the cat is the predefined, particular cat, the control unit 20 in step 82 causes the radio-frequency signal generator 14 to transmit an identification signal, which is suitable to enable an opening of the RFID-controlled cat flap. The radio-frequency signal generator 14 can transmit an identification signal which encodes an identity that is stored in the RFID-controlled cat flap as access-authorized. For this purpose, the RFID-controlled cat flap may have been pre-programmed with a corresponding identity. It is also possible that the radio-frequency signal generator is configured to send an identification signal with a master identity of the RFID-controlled cat flap.

The effect achieved by means of the method illustrated in FIG. 6 is that a cat, which is intended to have access to a building, but has no RFID tag implanted or does not wear an RFID tag, is granted access to the building by visual identification. There can be implemented an access control based on biometric identification of a predefined particular cat via the supplementary access control system 2.

Upon emission of the identification signal in step 82, the supplementary access control system 2, in particular the microcontroller 16, enters into a standby state in step 84. The supplementary access control system 2 wakes up from this standby state during the next detection of an approaching cat by means of the sensor 8, as described above with reference to step 70. Also, due to the determination that the cat is not the predefined, particular cat, the supplementary access control system 2 transitions to the standby state in step 84.

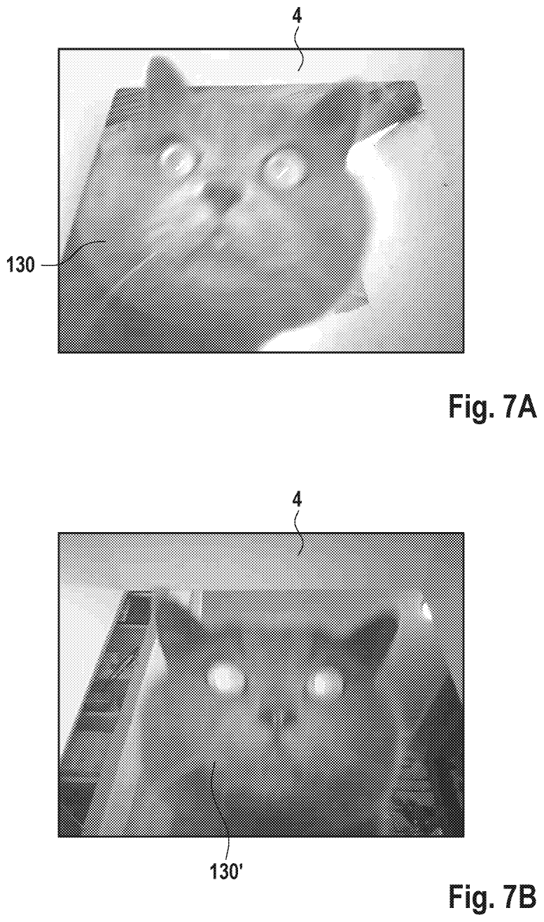

FIG. 7 shows two exemplary images of two different cats as they may be captured and processed by a supplementary access control system according to an exemplary embodiment of the invention.

FIG. 7A shows an image of a first cat 130, which in the nomenclature used herein is a predefined particular cat. The head of the cat 130 in the image shown is enclosed by the frame structure 4 of a supplementary access control system 2, as shown e.g. in FIG. 2. Between the head of the cat 130 and the frame structure 4, a section of the surroundings of the supplementary access control system 2 can be seen as an image background.

FIG. 7B shows an image of a second cat 130′, which in the nomenclature used herein, is not the predefined, particular cat. Again, the head of the cat 130 in the image shown is enclosed by the frame structure 4, and a section of the surroundings of the supplementary access control system 2 can be seen as an image background.

As is apparent from the comparison of the images of FIGS. 7A and 7B, images recorded by the camera 10 of a supplementary access control system 2 can differ in many respects, such as, for example, in the illumination, in the viewing direction of the cat 130 or 130′, in the blur of the image, in the brightness of the background, etc. Despite this multiplicity of degrees of freedom in the image composition, it has been found that artificial intelligence having been trained with approximately 400 images of predefined, particular cats and approx. 400 images of other cats, may reach a hit rate of greater than 95% or even greater than 99% in the analysis of newly captured images with respect to the determination as to whether the cat is the predefined, particular cat. This is even the case when the artificial intelligence is to distinguish between very similar cats, such as the siblings shown in FIGS. 7A and 7B.

With reference to FIG. 4 and FIG. 5, on the one hand, and FIG. 6 and FIG. 7, on the other hand, the aspects of the determination as to whether the cat is carrying a prey animal in its mouth and the determination as to whether the cat is a predefined, particular cat have been described separately. It is again expressly emphasized that it is possible that the two aspects are implemented jointly. The methods of FIG. 4 and FIG. 6 may be implemented jointly in a supplementary access control system. In this case, some steps may be carried out once and be used for both aspects.

In the above-mentioned description of FIG. 4 and FIG. 6, it has been stated that the part of the image processing unit that determines whether the cat is carrying a prey animal in its mouth is implemented in the cloud, whereas the part of the image processing unit that determines whether the cat is a predefined particular cat, is implemented locally. This splitting is very efficient in so far as the artificial intelligence that is pre-trained for the first-mentioned determination can be used for a plurality of supplementary access controls cooperating with a plurality of RFID-controlled cat flaps. In this respect, it is possible that only one implementation of an artificial intelligence is kept available, maintained and updated, while however the functionality of a plurality of RFID-controlled cat flaps is available. The second-mentioned determination by definition depends on a predefined, particular cat and normally makes sense only in conjunction with a particular RFID-controlled cat flap. The re-usability of a correspondingly trained artificial intelligence is thus limited, and local implementation may be desirable. However, it is expressly emphasized that other splittings or distributions between cloud and local implementation are possible and that a complete implementation of the image processing unit in the cloud or locally is possible as well.

Furthermore, it is expressly emphasized that the functionality of the supplementary access control system, as described with reference to FIGS. 2 to 7, may be integrated into an RFID-controlled cat flap, such as the RFID-controlled cat flap of FIG. 1. The RFID-controlled cat flap of FIG. 1 may be an RFID-controlled cat flap according to an exemplary embodiment of the invention.

Although the invention has been described with reference to exemplary embodiments, it will be apparent to those skilled in the art that various changes may be made and equivalents be used, without departing from the scope of the invention. The invention is not intended to be restricted by the specific embodiments described. Rather, it comprises all embodiments falling into the scope of the appended claims.

1. A supplementary access control system for an RFID-controlled cat flap, comprising:
a sensor for detecting an approaching cat and a camera for recording at least one image of the approaching cat
an image processing unit coupled to the camera and configured to determine, on the basis of the at least one image, whether the cat is carrying a prey animal in its mouth;
a radio-frequency signal generator configured to transmit an interfering signal, wherein the interfering signal is suitable to prevent an opening of the RFID-controlled cat flap and
a control unit coupled to the sensor to the image processing unit and to the radio-frequency signal generator the control unit being configured:
to cause the radio-frequency signal generator on the basis of the detection of the approaching cat to transmit the interfering signal; and
to cause the radio-frequency signal generator on the basis of the determination by the image processing unit that the cat is not carrying a prey animal in its mouth, to terminate the transmission of the interfering signal.

2. The supplementary access control system for an RFID-controlled cat flap according to claim 1,
wherein the image processing unit is configured to analyze the at least one image with an artificial intelligence as to whether the cat is carrying a prey animal in its mouth.

3. The supplementary access control system for an RFID-controlled cat flap according to claim 2,
wherein the artificial intelligence comprises a neural network, in particular a convolutional neural network.

4. The supplementary access control system for an RFID-controlled cat flap according to claim 2,
wherein the artificial intelligence is a pre-trained artificial intelligence, wherein the artificial intelligence has in particular been pre-trained with at least 200 images of cats without prey animals in the mouth and at least 200 images of cats with prey animals in the mouth, which are correspondingly annotated.

5. The supplementary access control system for an RFID-controlled cat flap according to claim 1,
wherein the control unit is configured, during predetermined blocking times, to cause the radio frequency generator to transmit the interfering signal, regardless of whether the image processing unit determines that the cat is carrying or not carrying a prey animal in its mouth.

6. The supplementary access control system for an RFID-controlled cat flap according to claim 1,
wherein the radio-frequency signal generator is configured to transmit an interfering signal having a fundamental frequency of between 100 kHz and 200 kHz, in particular having a fundamental frequency of between 120 kHz and 140 kHz; and/or
wherein the radio-frequency signal generator is configured to modulate a random or pseudo-random identification number onto a fundamental oscillation of the interfering signal, or wherein the radio-frequency signal generator is configured to modulate a random or pseudo-random bit pattern onto a fundamental oscillation of the interfering signal.

7. The supplementary access control system for an RFID-controlled cat flap according to claim 1, further comprising:
a network connection in particular a wireless network connection, more particularly a WLAN connection.

8. The supplementary access control system for an RFID-controlled cat flap according to claim 7,
wherein the supplementary access control system is a distributed system, in which the image processing unit or a part of the image processing unit is implemented remotely from the sensor the camera the radio-frequency signal generator and the control unit
wherein the supplementary access control system is in particular configured to transmit the at least one image to the image processing unit via the network connection and to receive the determination as to whether the cat is carrying a prey animal in its mouth via the network connection

9. The supplementary access control system for an RFID-controlled cat flap according to claim 7,
wherein the control unit and the image processing unit are integrated, and wherein the image processing unit is configured to receive an installation of an artificial intelligence trained with an extended data base via the network connection

10. The supplementary access control system for an RFID-controlled cat flap according to claim 1,
wherein the sensor is a passive infrared sensor, wherein the passive infrared sensor is in particular configured to cause the supplementary access control system, on the basis of the detection of the approaching cat to transition from a standby state to an operating state.

11. The supplementary access control system for an RFID-controlled cat flap according to claim 1,
wherein the sensor is configured as a distance sensor and/or wherein the supplementary access control system comprises an additional distance sensor coupled to the control unit and
wherein the sensor or the additional distance sensor provides a signal indicating the distance of the approaching cat and the control unit is configured to control the trigger time for recording the at least one image on the basis of the distance of the approaching cat and/or
wherein the sensor or the additional distance sensor is configured to continuously monitor the presence of the approaching cat

12. The supplementary access control system for an RFID-controlled cat flap according to claim 1,
wherein the supplementary access control system is an autonomously operating system; and/or
wherein the supplementary access control system comprises an internal power supply in particular a rechargeable battery.

13. The supplementary access control system for an RFID-controlled cat flap according to claim 1,
wherein the supplementary access control system is adapted to be mounted to the RFID-controlled cat flap or to a building structure, wherein the supplementary access control system in particular has a frame structure which can be inserted into a door breakthrough and/or into a window breakthrough and/or into a wall breakthrough and/or which can be attached to an RFID-controlled cat flap.

14. An RFID-controlled cat flap, comprising:
a mounting device with which the RFID-controlled cat flap can be mounted to a building wall and/or to a building door and/or to a building window;
a door element that is pivotable with respect to the mounting device
a closing mechanism that selectively enables opening of the pivotable door element
an RFID-based control configured to communicate with an RFID tag worn by a cat approaching the RFID-controlled cat flap and configured to cause the closing mechanism to enable an opening of the pivotable door element when it detects an approved RFID tag and
a supplementary access control system according to claim 1.

15. The RFID-controlled cat flap according to claim 14,
wherein the supplementary access control system is integrated into the RFID-controlled cat flap, or
wherein the supplementary access control system is configured as an independent system and is arranged with respect to the RFID-based control such that the camera of the supplementary access control system is capable of recording the at least one image of the cat approaching the RFID-controlled cat flap

16. A method for supplementary control of access through an RFID-controlled cat flap, wherein the RFID-controlled cat flap is configured to communicate with an RFID tag worn by a cat approaching the RFID-controlled cat flap, and to selectively enable an opening of the RFID-controlled cat flap comprising the following steps:
detecting a cat approaching the RFID-controlled cat flap
on the basis of the detection of the cat approaching the RFID-controlled cat flap emitting a radio-frequency interfering signal suitable to prevent an opening of the RFID-controlled cat flap;
recording at least one image of the cat approaching the RFID-controlled cat flap
on the basis of the at least one image, determining whether the cat is carrying a prey animal in its mouth; and
on the basis of the determination that the cat is not carrying a prey animal in its mouth, terminating the emission of the radio-frequency interfering signal.

17. (canceled)

18. A supplementary access control system for an RFID-controlled cat flap, comprising:
a sensor for detecting an approaching cat and a camera for recording at least one image of the approaching cat
an image processing unit that is coupled to the camera and configured to determine, on the basis of the at least one image, whether the cat is a predefined, particular cat;
a radio-frequency signal generator configured to transmit an identification signal, wherein the identification signal is suitable to enable an opening of the RFID-controlled cat flap and
a control unit coupled to the sensor to the image processing unit and to the radio-frequency signal generator wherein the control unit on the basis of the determination of the image processing unit that the cat is the predefined particular cat, is configured to cause the radio frequency generator to transmit the identification signal.

19. The supplementary access control system for an RFID-controlled cat flap according to claim 18,
wherein the image processing unit is configured to analyze the at least one image with an artificial intelligence as to whether the cat is the predefined, particular cat.

20. The supplementary access control system for an RFID-controlled cat flap according to claim 19,
wherein the artificial intelligence comprises a neural network, in particular a convolutional neural network.

21. The supplementary access control system for an RFID-controlled cat flap according to claim 19,
wherein the artificial intelligence is a pre-trained artificial intelligence, wherein the artificial intelligence has in particular been trained with at least 200 images of the predefined particular cat and at least 200 images of other cats, which are correspondingly annotated.

22. An RFID-controlled cat flap, comprising:
a mounting device, with which the RFID-controlled cat flap can be mounted to a building wall and/or to a building door and/or to a building window;
a door element that is pivotable with respect to the mounting device
a closing mechanism that selectively enables an opening of the pivotable door element;
an RFID-based control configured to communicate with an RFID tag worn by a cat approaching the RFID-controlled cat flap and to cause the closing mechanism to enable an opening of the pivotable door element when it detects an approved RFID tag and
a supplementary access control system according to claim 18.

23. The RFID-controlled cat flap according to claim 22,
wherein the supplementary access control system is integrated into the RFID-controlled cat flap, or
wherein the supplementary access control system is configured as an independent system and is arranged in relation to the RFID-based control such that the camera of the supplementary access control system is capable of recording the at least one image of the cat approaching the RFID-controlled cat flap

24. A method for supplementary control of access through an RFID-controlled cat flap, wherein the RFID-controlled cat flap is configured to communicate with an RFID tag worn by a cat approaching the RFID-controlled cat flap and to selectively enable an opening of the RFID-controlled cat flap, comprising:
detecting a cat approaching the RFID-controlled cat flap
recording at least one image of the cat approaching the RFID-controlled cat flap
on the basis of the at least one image, determining whether the cat is a predefined, particular cat; and
on the basis of the determination that the cat is a predefined, particular cat, emitting an identification signal suitable to enable an opening of the RFID-controlled cat flap

25. (canceled)
